(19) United States
(12) Patent Application Publication
(10) Pub. No.: US 2016/0356242 A1
(43) Pub. Date: Dec. 8, 2016

(54) TiO2 APPLICATION AS BONDCOAT FOR CYLINDER BORE THERMAL SPRAY

(71) Applicant: GM Global Technology Operations LLC, Detroit, MI (US)

(72) Inventors: Ronald J. Petrus, Lake Orion, MI (US); Martin S. Kramer, Clarkston, MI (US)

(21) Appl. No.: 14/733,121

(22) Filed: Jun. 8, 2015

(51) Int. Cl. F02F 7/00; C23C 4/08; C25D 7/04; C23C 4/02; C25D 5/44; C25D 5/34; C23C 28/00; C25D 9/04

(52) U.S. Cl. CPC F02F 7/0095; F02F 7/0007; C23C 28/32; C23C 4/08; C25D 9/04; C23C 4/02; C25D 5/44; C25D 5/34; C25D 7/04

(57) ABSTRACT

An engine cylinder bore with a plated bondcoat and a method of coating the surface of an engine cylinder bore. This method includes electroplating a bondcoat to the surface such that a substantial entirety of its inner circumference that corresponds to a piston travel path within the cylinder bore is covered. Cleaning or related pretreatment operations to properly activate the plated surface helps to ensure a durable coupling of a subsequently-applied thermal spray coating. In one preferred form, the cylinder bore is made from an aluminum-based alloy or a magnesium-based alloy that may be roughened prior to applying the bondcoat, while the bondcoat is plated using a titanium-based material such that a relatively thin TiO₂ layer is formed on the cylinder bore. In another preferred form, the thermal spray coating is made of an iron-based material.

### BACKGROUND OF THE INVENTION

This invention is related generally to achieving better adhesion between a thermal sprayed protective coating and a target substrate, and in particular to the use of a plated bondcoat on the surface of a cylinder bore to improve adhesion between it and a subsequently-applied thermal sprayed coating such that a separate bore liner is not required.

The cylinder walls of an internal combustion engine (ICE) are manufactured to exacting standards with tight tolerances between them and the engine's reciprocating piston as a way to promote efficient engine operation. The attainment of more power from higher revving speeds and hotter, more complete combustion processes places additional loads on engines in ways that can negatively impact their durability, especially in engine configurations that employ lighter-weight materials that may not be as robust as their iron-based counterparts. Nowhere are these issues of more concern than in the increased thermal and friction loads imparted to the cylinder walls of the engine block that—along with the pistons and spark mechanisms—make up the combustion chamber of these advanced engine designs.

A conventional way to provide protection for cylinder bores made from lightweight engine alloys is to use a separate cylinder sleeve (also referred to as a liner). In a conventional form, the sleeve is made from an iron-based material. While such sleeves are useful for their intended purpose, they add significant weight to an engine (for example, up to 5 pounds for a four-cylinder engine). Moreover, by being separate components designed to fit within the aforementioned exacting dimensions of the cylinder bore, they too require precise dimensions to ensure secure, durable placement; in addition to increasing weight, the use of these separate sleeves part undesirably adds to manufacturing and related part inventory costs.

Thermal spray techniques have been shown to be a way to deposit protective coatings—such as thermal barrier coatings, wear coatings, anti-corrosion coatings or the like—onto a workpiece. The high deposition rates make such coating approaches amenable to large-scale manufacturing, such as that associated with the production of the aforementioned cylinder bores, as well as the pistons that are designed to reciprocate in them. Examples of known thermal spray techniques include plasma transferred wire arc (PTWA), rotating single wire (RSW), high velocity oxygen fuel (HVOF), powder plasma and two wire arc (TWA). The present inventors have previously investigated ways to use thermal spray coatings as a way to obviate cylinder sleeves, but have found that such coatings suffer from durability issues related to the inability of the coating to adhere to the wall of the cylinder bore, much of this due to thermally-induced stresses and concomitant cracking.

Adhesion of a thermal spray protective coating to a substrate is a very important metric for determining the suitability of the coating for a particular application. Traditionally, improvements in coating adhesion to the substrate were achieved through various surface activation pretreatment steps, including approaches such as grit blasting with ceramic particles, high-pressure water jet blasting and mechanical locking (such as through dovetailing or related undercuts). While effective for their intended purpose, they add complexity and cost to the coated component's manufacturing process. For example, mechanical locking-based approaches involve high tooling costs; these costs tend to be exacerbated by short tool life and extensive cleanup and inspection requirements. Likewise, the high-pressure water jet blasting approach has very high capital costs, while the grit blasting approach has sand contamination problems, as well as (along with the mechanical locking mentioned above) significant cleanup requirements. Some of these cleanup requirements (as well as substrate pretreatment) may also use volatile organic compounds (VOCs) the use of which is coming under increasing scrutiny for their potentially negative environmental impact.

An alternative to the conventional surface preparation techniques (such as the water jetting, grit blasting or mechanical locking discussed above) is to anodize a coating (for example, alumina (Al₂O₃) in an electrolyte solution directly onto the substrate. Unfortunately, such an approach leaves a relatively porous surface that has poor tribological (i.e., wear) qualities between the cylinder bore and the piston that repeatedly reciprocates therein. For example, such coatings tend to be rather thick (often between about 20 μm and about 50 μm), and have high roughness (often greater than about 5.0 μm) and hardness (often between about 800 Hv and 1400 Hv) values. Moreover, they tend to suffer from insufficient wear toughness and related robustness. As such, there remains a need for an alternative to these known approaches for adhering protective coatings to substrates in general, and to the walls of engine cylinder bores in particular.

### SUMMARY OF THE INVENTION

According to an aspect of the present invention, a method of coating the surface of an aluminum-based engine cylinder bore substrate includes plating a bondcoat to the surface such that it cover a substantial entirety of the circumferential surface of the cylinder bore, and depositing one or more layers of thermal spray coating once the bondcoated surface has been activated. In the present context, the substantial entirety of the cylinder bore includes those portions that are exposed (or could reasonably expected to be exposed) to the combustion process. In other words, the portion of the cylinder bore that defines the fluctuating volume that corresponds to the piston travel path along the length or height of the cylinder wall where the working fluid is introduced, mixed with fuel, ignited and exhausted constitutes its substantial entirety for the purposes of the present disclosure. As such, the substantial entirety need not encompass those parts of the cylinder bore that are beneath the travel path of the piston (i.e., on the opposite side of the piston from the combustion chamber), although such surfaces that are not exposed to the combustion process may also be treated by the present invention, if so desired. Moreover, by plating the bondcoat onto the surface, chemical bonding takes place between them to achieve a degree of bonding that can't be replicated by mere coating techniques (such as various vapor deposition or plasma spraying techniques) where there is only adhesion of the bondcoat to the substrate. In so doing, the surface activation and coating of the present invention is achieved without the negative externalities associated with traditional blasting, spraying or mechanical locking approaches such as those discussed above. This in turn helps, in some instances, to simplify such pretreatment, while in others, such pretreatment may be avoided altogether. In one preferred form, the thermal spray coating is a wear coating.

According to another aspect of the present invention, a method of forming an interface between an engine cylinder bore surface and a piston disposed therein is disclosed. The method includes defining a cathode and an anode within a plating or anodizing solution as part of an electroplating bath, placing a titanium-based metal article in the plating solution; applying an electric current between the anode and the cathode through the plating solution such that a bondcoat that is an oxide of titanium is formed on the surface of the cylinder bore, activating the plated surface, depositing a thermal spray coating on the activated surface; and placing the piston within the cylinder bore such that upon operation of an engine that incorporates the cylinder bore and the piston, the piston reciprocates along a travel path substantially coated with the bondcoat and the thermal spray coating. A material making up the cylinder bore is preferably an aluminum-based material, a magnesium-based material or a combination of both, while the bondcoat is preferably TiO₂-based, and the thermal spray coating is an iron-based wear coating.

According to yet another aspect of the present invention, an internal combustion engine component made up of an engine block that has numerous cylinder bores formed therein and a bondcoat plated onto a surface defined by the cylinder bores is disclosed. As before, the bonding between the two results in a substantial entirety of the bores' inner circumference being covered. In a preferred form, the combination of the bondcoat and the thermal spray coating permit the engine block to be operated without separate sleeves, liners or related inserts.

### BRIEF DESCRIPTION OF THE DRAWINGS

The following detailed description of the preferred embodiments of the present invention can be best understood when read in conjunction with the following drawings, where like structure is indicated with like reference numerals and in which the various components of the drawings are not necessarily illustrated to scale:

FIG. 1 depicts a view of a notional engine block with four cylinder bores formed therein that could receive a plated bondcoat and protective coating according to an aspect of the present invention;

FIG. 2 depicts a simplified view of plating a bondcoat onto the wall of an engine cylinder bore of the engine block of FIG. 1;

FIGS. 3A and 3B depict two applied bondcoats with respective thin and moderate layers and corresponding increases in degrees of roughness, pore size and pore density;

FIG. 4 depicts the cooperative placement of a thermal spray device with the wall of an engine cylinder bore of the engine block of FIG. 1; and

FIG. 5 shows a magnified view of the cooperation between the wall of an engine cylinder bore, the plated bondcoat and a protective coating that is deposited using the devices of FIGS. 2 and 4.

### DETAILED DESCRIPTION OF THE PREFERRED EMBODIMENT

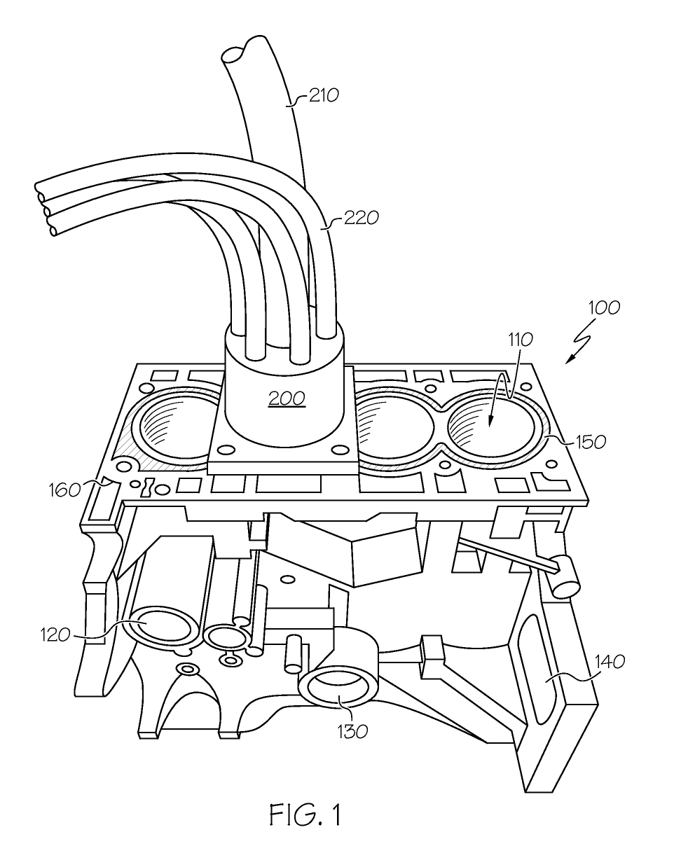

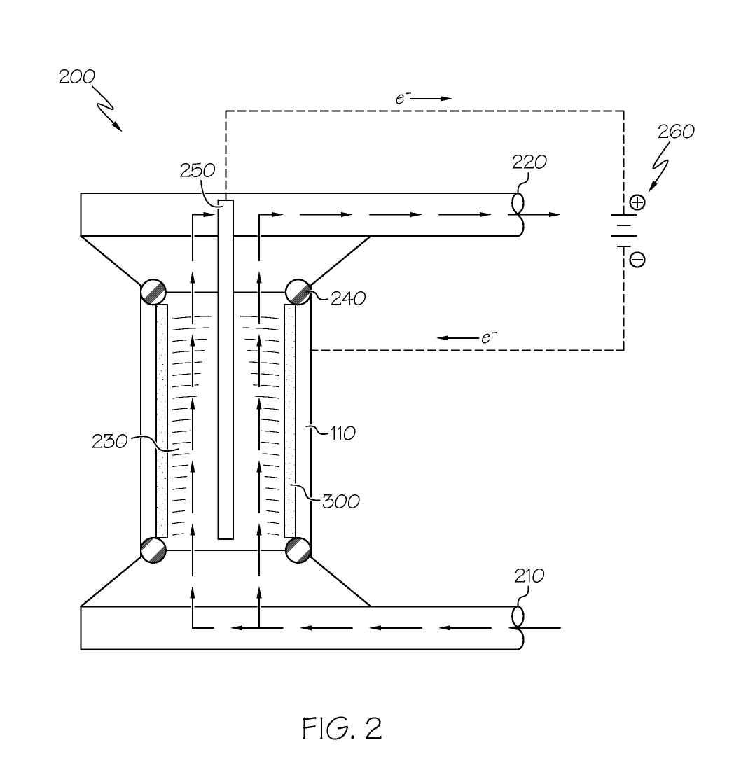

Referring first to FIGS. 1 and 2, a simplified view of four-cylinder automotive internal combustion engine block 100 is shown with a notional electroplating bath 200 placed on one of the cylinder bores 110. In addition to the bore 110, and depending on the engine configuration, the block 100 includes portions for—among other things—the crankcase, crankshaft bearings, camshaft bearings (none of which are presently shown), coolant or lubricant flowpaths 120, power takeoff connectors 130, vehicular integration/mounting hardware 140, water cooling jackets 150 and head mounting hardware 160. As mentioned above, traditionally, these bores 110 have included a separate heavy cast iron insert or sleeve (typically up to about 2 to 2.5 mm in thickness) that is sized to fit securely within. In fact, in engine configurations where the block 100 is cast from a lightweight material, such as aluminum and its alloys (such as A380, A319 or A356) or magnesium or its alloys, the addition of such liners was traditionally deemed to be necessary as a way to impart additional thermal and wear resistance. By contrast, the combined thickness of the bondcoat and thermal spray coating of the present invention that can be used to obviate the need for such liners is significantly (for example, least an order of magnitude) thinner.

The bath 200 that includes an aqueous solution (not shown, also referred to herein as a plating solution) is the foundation for an electroplating technique used to achieve a chemical bond between the alloy that makes up the inner wall of the cylinder bore 110 and a bondcoat 300. Such bonding forms a more integral, robust joining of the two than is possible with the mere adhesive action of a coating applied to the aluminum or other light metal-based substrate. In the present context, reference to the substrate, surface, inner wall, circumferential surface or like terms shall be construed to include the inner wall of a cast cylinder block 100 that by the present coating may eschew a separate cylindrical-shaped sleeve, insert or related liner configured to fit within the bore 110.

Traditionally, electroplating of reactive metals (such as titanium) has been deemed to be difficult to achieve with an aqueous medium because of the large negative reduction-oxidation (redox) potential relative to the hydrogen; in such a configuration, hydrogen preferentially reduces, leaving much (if not substantially all) of the titanium unreacted. These difficulties are particularly acute in solutions other than those that are the most acidic (for example where the pH level is greater than about 1). However, recent improvements have shown that suitably-modified aqueous solutions may be used; such solutions may include (in addition to the titanium-containing ion, which in one form may be a water-soluble titanium salt such as titanium trichloride or titanium tetrachloride) a nitric acid ion (such as nitric acid, ammonium nitrate, potassium nitrate, sodium nitrate or the like), a peroxide (such as hydrogen peroxide, peroxoacid, peroxocarbonate, peroxophosphate, peroxoborate or the like) and a complexing agent (such as an EDTA-based salt, citric acid salt, nitrotriacetate, cyclohexanediaminetetraacetic acid or the like) with a specific pH value in the range of about 3.0 to 9.0, and more particularly to values between about 5.0 and 8.0. Examples of such a solution may be found in Japanese Published Application 11-158691 entitled AQUEOUS SOLUTION FOR FORMING TITANIUM OXIDE FILM, AND PRODUCTION OF TITANIUM OXIDE FILM that was published on Jun. 15, 1999, as well as in a Journal of the Electrochemical Society article entitled CATHODIC ELECTRODEPOSITION OF NANOCRYSTALLINE TITANIUM DIOXIDE THIN FILMS, (vol. 143, No. 5, May 1996); both of these references are incorporated in their entirety by reference.

Although shown presently in simplified form as being applied to just one of the four cylinder bores 110 of block 100 as a way to describe the invention, it will be appreciated by those skilled in the art that the use of a full-immersion equivalent of bath 200 may also be employed. Nevertheless, in a preferred form, targeting coating is preferable in that it avoids placing extraneous coating onto places where it may not be needed. In one form, the plating solution 230 is continuously fed into and removed from the bath 200 through respective inlets 210 and outlets 220; this helps ensure that the solution 230 maintains a known electrolyte concentration. In one exemplary form, a pump (not shown) may be used to introduce fresh plating solution 230 into bath 200, while outlet 220 may be in the form of a top-mounted drain 220 to remove excess plating solution 230. In one preferred form, the plating operation takes place in between about 1 and 5 minutes, at relatively low temperatures (such as between about 60° F. and 120° F.), and involves the application of current through a known potentiodynamic, potentiostatic, galvanodynamic or galvanostatic means (such as between about 300 V_{DC} and 450 V_{DC}).

Referring with particularity to FIG. 2, non-conductive isolators 240 (shown presently in the form of O-rings, gaskets or the like) may be placed between the bath 200 and the top and bottom of each bore 110 within the engine block 100 to provide fluid-tightness of the solution that is used in the bore. Once such fluid-tightness is ensured, the plating solution 230 may be introduced in order to commence the electroplating operation. A titanium-based cathode 250 that fits within the volume defined by the cylinder bore 110 is placed within the plating solution 230 so that it, along with the bore 110 that forms the anode and the solution 230 and cathode 250 making up electrolytic coupling. In one form, cathode 250 may be an elongated rod. A source 260 (such as a generator, battery or the like) of electric current is selectively coupled to the anode (in the form of the cylinder bore 110) and the cathode 250 to deliver the electrical potential needed to cause current flow. Depending on the desired thickness of the formed bondcoat 300, the plating process preferably takes no more than about 5 minutes, and more preferably no more than about 60 seconds.

Because of the presence of agents (such as acids, cyanides, pH balancers or the like) within the plating solution 230, it may be preferable to perform some activation steps once the bondcoat 300 has been applied as a way to promote better structural and related mechanical properties of the subsequently-applied thermal spray coating 400 (which will be discussed in more detail below). In one particular form, the bondcoated cylinder bore 110 (along with the remainder of the engine block 100 in such configurations where a full-immersion bath 200 is employed) may be removed from the electroplating bath 200 and then subjected to one or more cleansing steps (none of which are shown), including degreasing, rinsing, deionizing, deoxidizing, micro-roughening texture or the like. Such micro-roughening may also be applied to the cylinder bore 110 prior to the plating operation. In one form, such roughening may be provided as part of the bore 110 being machined to its final (or nearly-final) dimension. In one form, the adhesion achieved by the present invention is at least about 40 MPa or more.

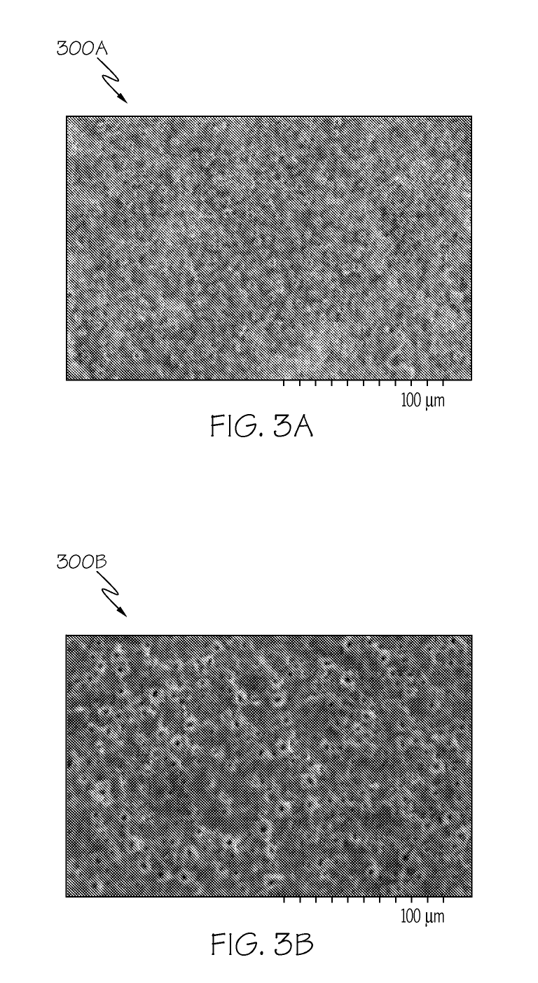

Referring next to FIGS. 3A and 3B, micrographs depicting the plating of a TiO₂ bondcoat 300 onto a cylinder bore 110 according to an aspect of the present invention is shown. FIG. 3A shows with particularity a coating 300A designed for mild wear applications; this coating is between about 5 μm and 6 μm in thickness, where the roughness can be controlled by the pre-machining of the bore 110 prior to any plating activities as mentioned above. In another form (not shown), coating 300A may be even thinner, on the order of about 3 μm. Likewise, FIG. 5B shows a smooth coating 300B designed for mild wear applications with a thickness of between about 10 μm and 12 μm with a hardness of about 300 Hv to about 800 Hv. In another form (not shown), coating 300B may be even thinner, on the order of between about 6 μm and about 10 μm. Thus, a preferable range of total thickness of the bondcoat 300 is between about 3 μm and about 50 μm, while that of the subsequently-applied thermal spray coating 400 is at least 100 μm. Significantly, high levels of porosity are evident in both coatings 300A and 300B. This indicates that significant chemical bonding (and attendant adhesion) are taking place, as the increased surface texture that the porosity provides allows for more locations for the thermal spray coating 400 to lock into place. Thus, while it is generally undesirable to leave an exposed layer (such as that of coatings 300A and 300B) with such a high degree of porosity, it is desirable to use it as the bondcoat 300 for a subsequently-applied layer of thermal spray coating 400. Regardless, the porosity of the bondcoat 300 should preferably be less than about 0.5 mm in diameter.

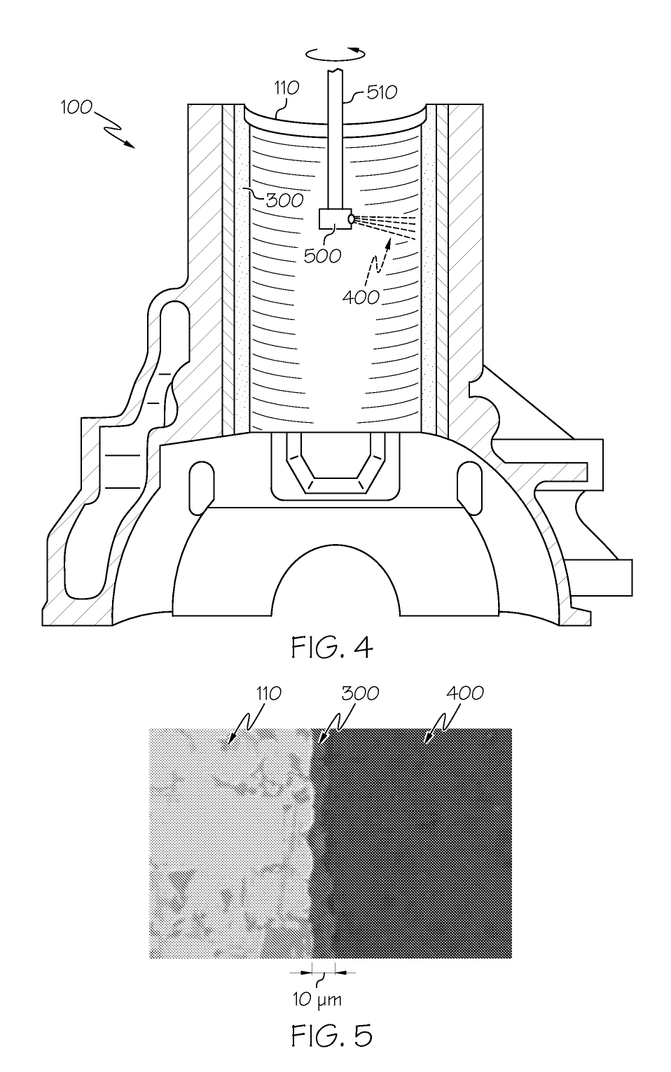

Referring next to FIGS. 4 and 5, once the bondcoat 300 is plated onto the inner wall of the cylinder bore 110, a process may be used to deposit the outer layer thermal spray coating 400. In one preferred form, the thermal spray coating 400 is in the form of a wear coating. In one preferred form, the thermal spray coating is iron-based, such as through a carbon steel alloy wire. The device used to apply the coating is preferably in the form of a plasma spray gun or more simply as a plasma gun) 500 that can be used as part of the present invention. Details associated with the plasma spray gun 500 may be found in co-pending U.S. application Ser. No. 14/535,404 entitled SURFACE ACTIVATION BY PLASMA JETS FOR THERMAL SPRAY COATING ON CYLINDER BORES that is owned by the Assignee of the present invention and incorporated herein by reference in its entirety. A stem (which may be made to rotate) in the form of a pressurized axial fluid conduit 510 may be used as a secure mounting platform for gun 500. Details of the cooperation between the rotating axial fluid conduit 510 and its use in cylinder bore 110 may be found in co-pending U.S. application Ser. No. 14/335,974 entitled NON-DESTRUCTIVE ADHESION TESTING OF COATING TO ENGINE CYLINDER BORE that is owned by the Assignee of the present invention and incorporated herein by reference in its entirety. Referring with particularity to FIG. 5, a micrograph depicting a portion of the wall of cylinder bore 110 that has been treated with the bondcoat 300 and thermal spray coating 400 is shown. The total protective coating is approximately 100 μm thick, with about 10 μm due to the bondcoat 300.

It is noted that terms like “preferably”, “generally” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention, it is noted that the terms “substantially” and “approximately” and their variants are utilized herein to represent the inherent degree of uncertainty that may be attributed to any quantitative comparison, value, measurement or other representation. The term “substantially” is also utilized herein to represent the degree by which a quantitative representation may vary from a stated reference without resulting in a change in the basic function of the subject matter at issue.

Having described the invention in detail and by reference to specific embodiments, it will nonetheless be apparent that modifications and variations are possible without departing from the scope of the invention defined in the appended claims. In particular it is contemplated that the scope of the present invention is not necessarily limited to stated preferred aspects and exemplified embodiments, but should be governed by the appended claims.

We claim:

1. A method of coating the surface of an engine cylinder bore, said method comprising:
activating said surface;
plating a bondcoat to said surface such that a substantial entirety of its inner circumference that corresponds to a piston travel path therein is covered thereby; and
depositing a thermal spray coating on said bondcoat-plated surface.

2. The method of claim 1, wherein a layer defined by said bondcoat is less than about 20 micrometers in thickness.

3. The method of claim 2, wherein a layer defined by said bondcoat is less than about 20 micrometers in thickness.

4. The method of claim 3, wherein a layer defined by said bondcoat is less than about 6 micrometers in thickness.

5. The method of claim 2, wherein said bondcoat comprises a ceramic oxide.

6. The method of claim 5, wherein said ceramic oxide comprises titanium dioxide.

7. The method of claim 1, wherein said thermal spray coating comprises at least one layer of an iron-based material.

8. The method of claim 7, wherein said thermal spray coating defines a wear coating.

9. The method of claim 1, wherein a material making up said cylinder bore is selected from the group consisting of an aluminum-based material, a magnesium-based material and combinations thereof.

10. The method of claim 1, wherein a material making up said bondcoat is different from a material making up said cylinder bore.

11. The method of claim 1, further comprising roughening said surface prior to said plating.

12. The method of claim 1, wherein said bondcoat defines a hardness of no more than about 800 Hv.

13. The method of claim 1, wherein said bondcoat and said thermal spray coating together are less than about 150 micrometers in thickness when formed on said cylinder bore.

14. The method of claim 1, wherein said activating is selected from the group consisting essentially of degreasing, rinsing, deionizing, deoxidizing and micro-roughening.

15. A method of forming an interface between a piston and an engine cylinder bore surface the latter of which is made from a material that is selected from the group consisting of an aluminum-based material, a magnesium-based material and combinations thereof, the method comprising:
activating said surface;
defining said activated surface as an anode;
placing a plating solution in fluid communication with said anode;
placing a titanium-based metal article as a cathode into fluid communication with said plating solution;
applying an electric current between said activated surface and said metal article through said plating solution such that a bondcoat that is an oxide of titanium is formed on said activated surface;
depositing a thermal spray coating on said bondcoat; and
placing said piston within said cylinder bore such that upon operation of an engine that incorporates said cylinder bore and said piston, said piston reciprocates therein along a travel path substantially coated with said bondcoat and said thermal spray coating.

16. The method of claim 15, wherein a substantial entirety of the inner circumference of said cylinder bore that corresponds to a piston travel path therein is covered by said bondcoat and said thermal spray coating such that no cylinder sleeve is disposed between.

17. The method of claim 16, wherein said thermal spray coating comprises an iron-based wear coating.

18. The method of claim 15, wherein said activating is selected from the group consisting essentially of degreasing, rinsing, deionizing, deoxidizing and micro-roughening.

19. The method of claim 15, further comprising treating said surface between said forming said bondcoat and said depositing a thermal spray coating, said treating being selected from the group consisting essentially of degreasing, rinsing, deionizing, deoxidizing and micro-roughening.

20. An internal combustion engine component comprising:
a block defining a plurality of cylinder bores therein;
a bondcoat plated onto a surface defined by said cylinder bores; and
a thermal spray coating deposited on said bondcoat such that a substantial entirety of their inner circumference that corresponds to a piston travel path therein is covered thereby.
